(19) United States
(12) Patent Application Publication
(10) Pub. No.: US 2014/0060437 A1
(43) Pub. Date: Mar. 6, 2014

(54) APPARATUS FOR THE TRANSPORTATION OF ANIMALS

(71) Applicant: Billy E. Gryner, JR., Batesville, AR (US)

(72) Inventor: Billy E. Gryner, JR., Batesville, AR (US)

(21) Appl. No.: 14/018,774

(22) Filed: Sep. 5, 2013

Related U.S. Application Data
(60) Provisional application No. 61/697,637, filed on Sep. 6, 2012.

(51) Int. Cl. A01K 1/035

(52) U.S. Cl. CPC A01K 1/0353
USPC 119/28.5

(57) ABSTRACT

In an example embodiment of a carrier described herein, a silicone/plastic material used in the carrier is such that it can be manipulated in a variety of ways and still be shock absorbent and flexible. The carrier frame is sturdy, cannot be bent out of shape and yet still remains very flexible. The pet liner comprises a tube with a baffle/rib that is inserted into each tube spaced at intervals throughout the structure. This gives it air pockets between the baffle/ribs. These tubes with baffle/ribs cover the bottom, back, and opposite sides with an open front. This frame sits inside a box, crate, carrier, cage, or trailer. It is covered with a durable material. It too has a back, bottom and opposite sides with an open front. It is also easily cleaned.

### CROSS-REFERENCE TO RELATED APPLICATION

This application claims priority to and the benefit of U.S. Provisional Application No. 61/697,637, filed Sep. 6, 2012, the entire contents of which are incorporated by reference for all purposes.

### FIELD OF THE INVENTION

The invention relates generally to an apparatus for providing a comfortable bed fₒᵣ pets and providing a safe bed for the transportation of animals.

### BACKGROUND OF THE INVENTION

There are various options for transporting animals safely that include seat belts and padded crates, but they focus on either the safety or comfort component of transportation, not both. Some of these solutions attempt to transport animals safely, but these solutions fail to meet the needs of the industry because a seat belt will not work for all animals. Other devices attempt to make transporting more comfortable for the animals, but these solutions are similarly unable to meet the needs of the industry because they do not address the backs or sides of the crate or cage structure, just the bottom.

Animals are transported millions of miles each year. The products available now are extremely inadequate. The product disclosed herein will give the animal owner a sense of confidence that a pet carrier provides optimal support for their pet carriers.

### BRIEF DESCRIPTION OF THE DRAWINGS

It would be desirable to have a crate or carrier liner that can be used for traveling on a regular basis as well as providing a bed that is comfortable for the animal. Furthermore, it would also be desirable to have a liner that has multiple layers of cushion for support of the animal's body. Still further, it would be desirable to have a liner that can fit inside of a crate or carrier and that creates a padded area for more than just the bottom or to have a liner that can fill the space of a trailer.

The invention advantageously fills the aforementioned deficiencies by providing a two piece pet bed. The first piece is a silicone or plastic tube-like structure with baffle-like ribs that runs the length of the tubes in the middle of the tube openings. This creates a pocket of air inside of tubs with flexibility and sturdiness. It has a bottom, and optional back and opposite sides. It is open in the front for easy access. The tubes extend from the bottom up the inside walls of the crate (back and opposite walls), and are protected because of the soft, flexible and sturdy material. The second piece is a memory foam insert formed to fit inside the tubular structure to give it two-ply protection. The carrier described herein is covered with a durable material and has a back, and optional bottom and opposite sides with an open front. It is also easily cleaned, which provides maximum comfort for the animals and low maintenance for the pet owners.

In an example embodiment, the pet bed has a top surface, a first sidewall and a second sidewall. The sidewalls are positioned substantially perpendicular to the top surface and are bounded to the top surface. The base member includes a plurality of hollow cells disposed between the top surface and the first and second sidewall. The hollow cells have a set of cell walls that are substantially parallel to the side walls and define a space therebetween. A pad member is adapted to be supported by the base member and is configured to resiliently support the pad member when in use through at least a temporary partial deformation of the hollow cells.

In another embodiment the pad member is made from a moisture absorbing material. In another embodiment the base portion is made from plastic, rubber, foam, memory foam, or silicone. The base member may also have a cover member. The cover member can be made from fabric, sodium polyacraylate, or plastic. The cover member may also be waterproof, odor proof, washable, or removable. The plurality of hollow cells may be filled with a liquid or gas. The hollow cells can be configured to form a support grid.

In another example embodiment, the top surface and/or the sidewalls are configured to provide side support for the pet. The top surface and sidewalls may form at least one upright member. The pad member may also be configured to line the top surface and upright members of the base member.

In still yet another embodiment, the pet bed has a base member with a top surface, first and second sidewall, wherein each sidewall is positioned substantially perpendicular to the top surface and each sidewall. The base member has a plurality of hollow cells disposed between the top surface and the first and second sidewalls. The hollow cells are comprised of a set of cell walls substantially parallel to the side walls, wherein the cell walls define a space therebetween and are configured to form a support grid under the top surface of the base member. The upright members are formed and adapted to provide side support for the pet or animal.

In still yet another embodiment, the pet bed has a pad member that is disposed on the top surface of the base member and is configured to line the upright member. The pad member may be made from a moisture absorbing material and/or a memory foam type material. The pad member may also be disposed on the top surface of the base member and is configured to line the base member and upright members. The base member may bₑ made from plastic, rubber, or silicone.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

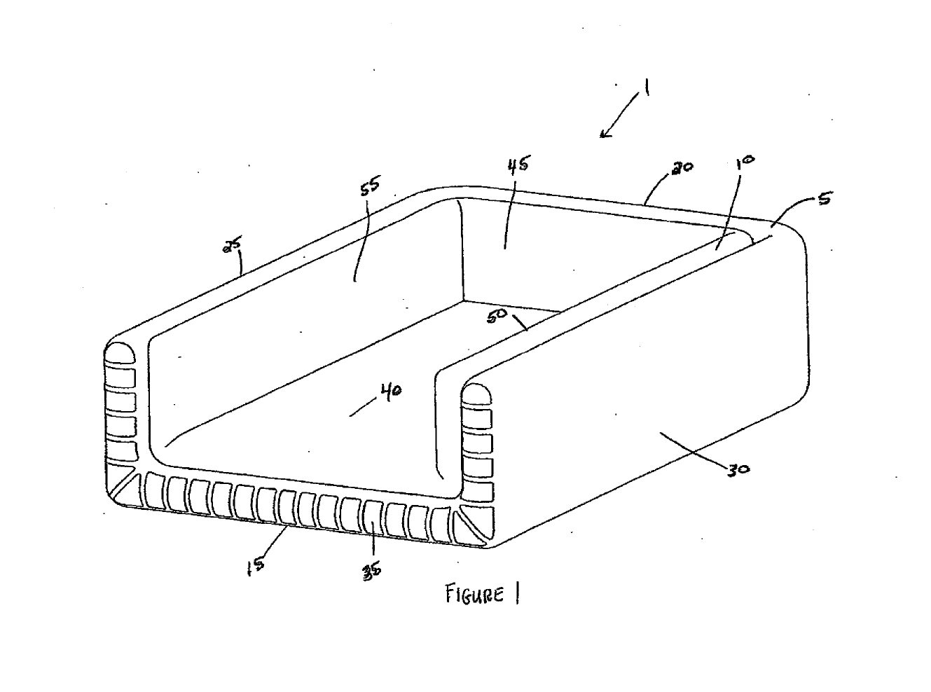

FIG. 1 shows an example embodiment of the pet bed;

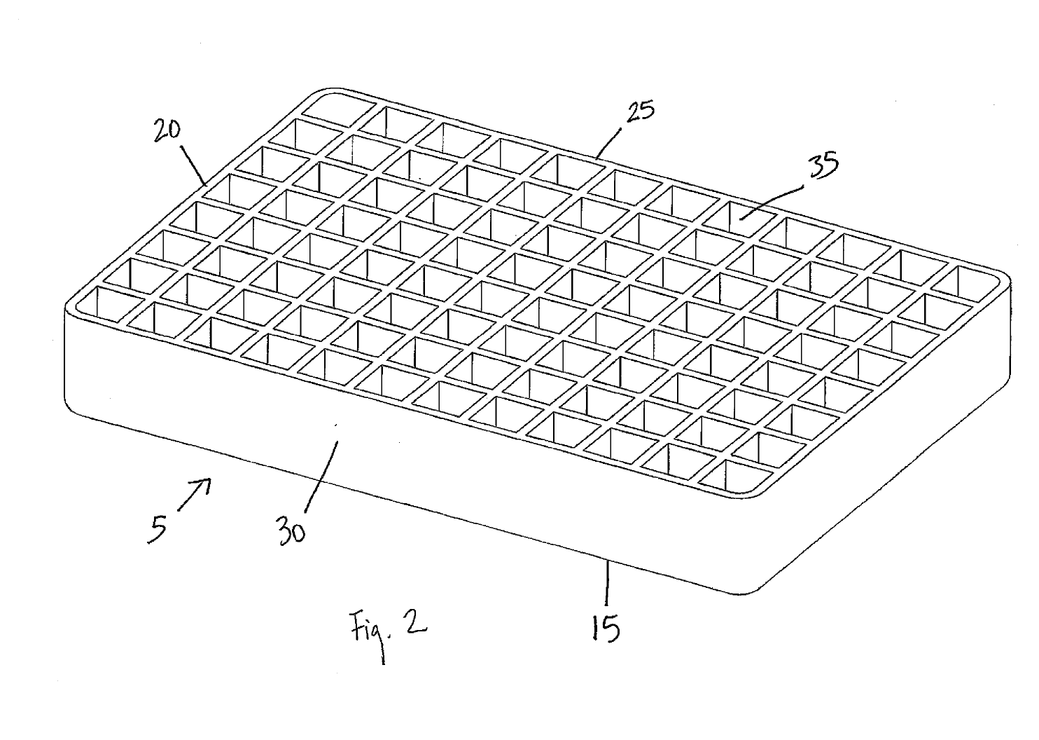

FIG. 2 shows a top view of the pet bed frame;

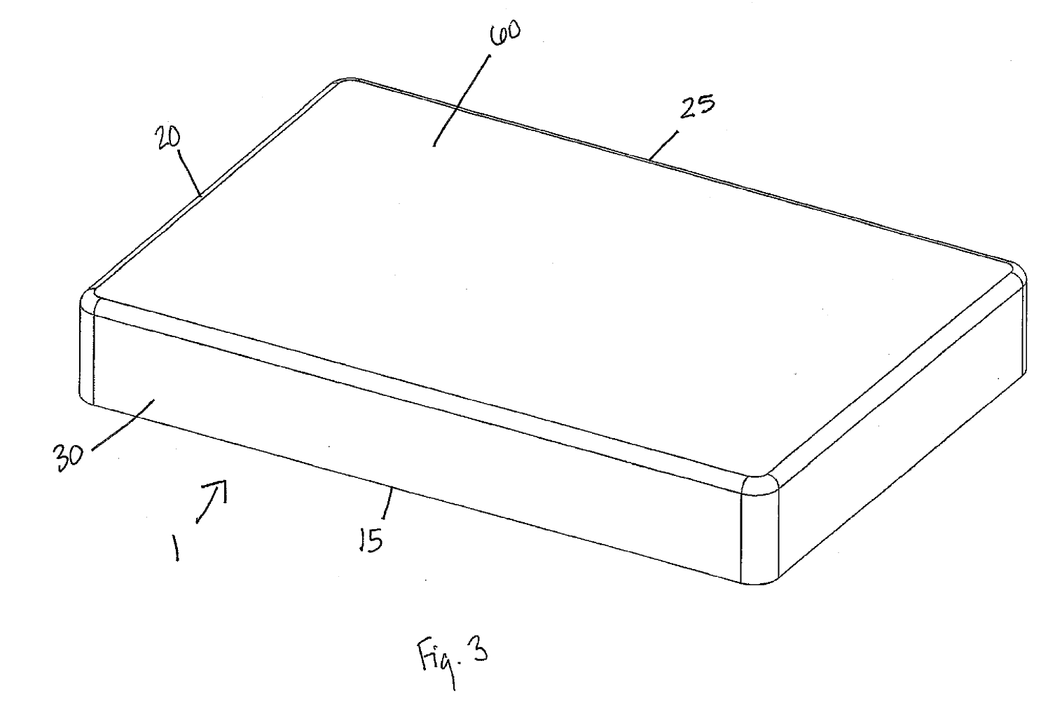

FIG. 3 shows a top view of the pet bed;

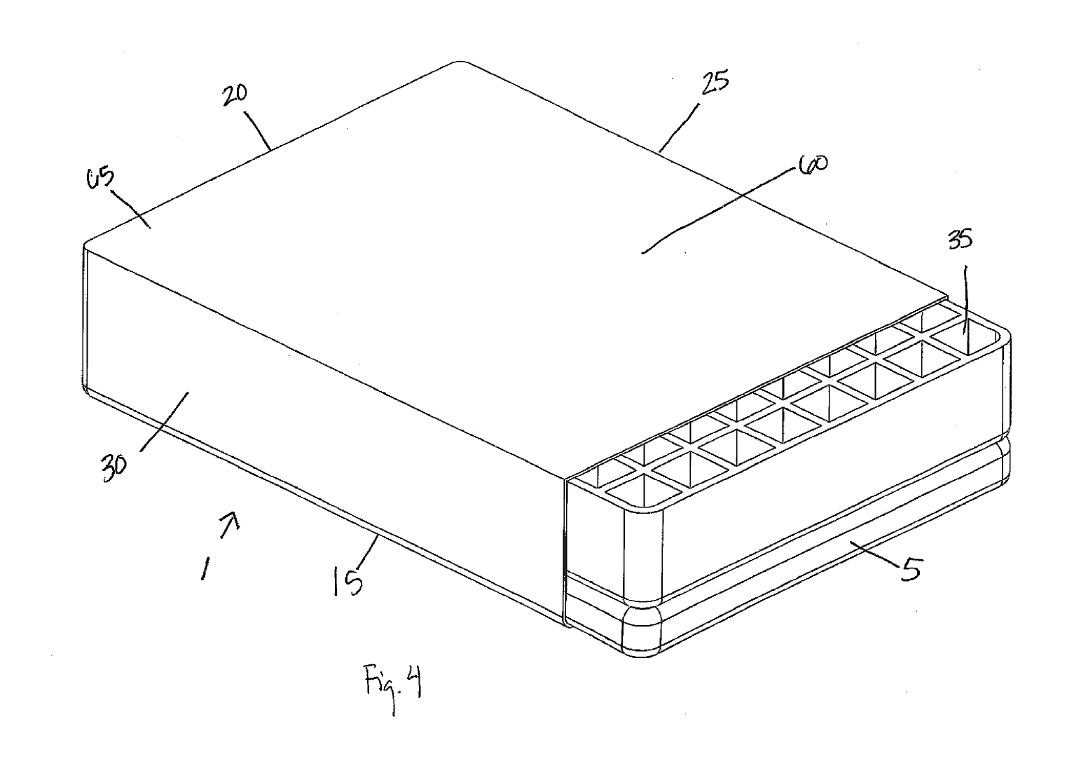

FIG. 4 shows an alternative embodiment of the pet bed;

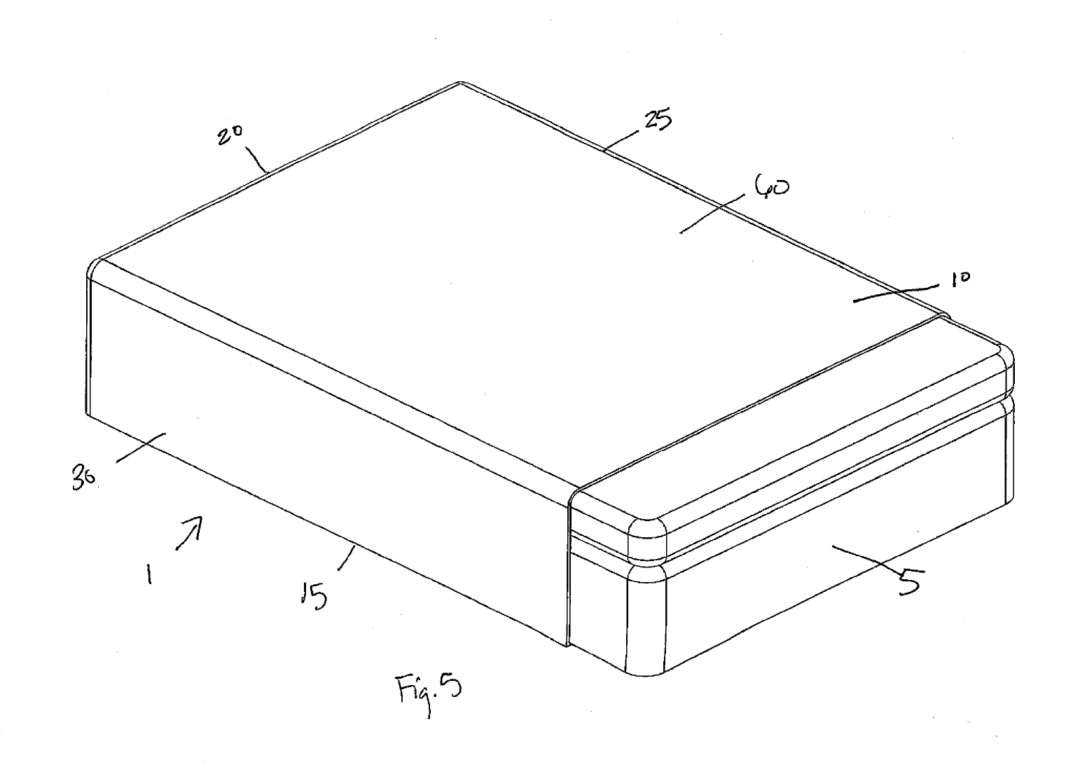

FIG. 5 shows another embodiment of the pet bed.

### DETAILED DESCRIPTION OF THE INVENTION

In an example embodiment of a pet bed described herein, a silicone or plastic material is used in the carrier such that it can be manipulated in a variety of ways and still be shock absorbent and flexible. The carrier frame is very sturdy, can't be bent out of shape and yet still remains flexible. The pet bed comprises a tube with a baffle/rib that is inserted into each tube spaced at intervals throughout the structure. This gives it air pockets between the baffle/ribs. These tubes with baffle/ribs cover the bottom, back, and opposite sides with an open front. This frame sits inside a box, crate, carrier, cage, or trailer. The inside bottom of the carrier is covered and can include the back and opposite walls. The frame insert also has a space for a custom-fit memory insert to provide a pet a more comfortable ride. This also covers the bottom, and optionally the back and opposite sides. The insert may also be covered with a durable fabric. This gives the animal a two-ply layer of shock absorption with added comfort so that now the animal can now sit, lay, stand or lean in comfort.

When an animal is loaded into their carrier the options to choose may include sitting, laying, standing, or leaning. The weight of the animal will self-activate the design feature of this invention. The silicone/plastic baffle/ribs and the created air pockets will perform to counter or absorb the pressure applied by the weight

The function is to make a more comfortable and safer ride for animals during transportation, as well as making it easier to clean and easier to maintain. The layers of protection and the details of design and materials provide a distinction from other prior art devices.

Referring now to FIG. 1, showing an example embodiment of a pet bed 1 in a two-piece assembly configuration comprising frame 5 and cushion assembly 10. Frame 5 is made to fit the area inside of any crate, cage, box, or trailer that is designed to contain animals. Frame 5 provides a means to relieve shock and vibration that an animal is subjected to while being transported.

Frame 5 may be constructed of silicone or plastic or other material known to one of ordinary skill that is flexible yet durable. The material used can also retain its shape. Frame 5 has a bottom 15, back 20, and opposing sides 25, 30. The back 20 and opposing sides 25, 30 are elevated from the bottom 15 and has a front that is open. FIGS. 2-5 illustrate a frame 5 that has a bottom 15, back 20, and opposing sides 25, 30 that are not elevated from the bottom 15.

Frame 5 also includes ribs 35 that provide shock absorbency through the silicone or plastic ribs attached to the length of the bottom 15, back 20, and opposing sides 25 and 30. Ribs 35 are positioned to give maximum support and are spaced in increments that are configurable according to the desired application and dictated as well by individual sizes of crates, etc. The ribs 35 are flexible, sturdy and retain their shape.

Frame 5 also may include an inner bottom, back and opposing sides (not shown). FIG. 1 illustrates an embodiment where the back 20 and opposing sides 25, 30 are elevated from the bottom 40. With this it creates air pockets within the ribs 35. The air pockets of the ribs 35 create cells that hold their own structure.

The ribs 35 can be arranged length-wise as shown in FIG. 1. In the alternative, ribs 35 can be arranged in a top-bottom configuration as shown in FIGS. 2 and 4. Ribs 35 may be open to the top 60 as shown in FIG. 2, or ribs 35 may be open to the bottom 15.

Alternatively, as shown in FIG. 3, ribs (not shown) may not be open to either the top 60 or bottom 15.

FIG. 4 shows another related embodiment. Frame 5 also provides a layered support system that is weight-pressure activated to assist in shock absorption. Frame 5 includes a bottom 15, top 60, and opposing sides 25, 30. Frame 5 contains ribs 35 that provide shock absorbency through the silicone or plastic ribs. The ribs 35 are arranged in a top-bottom configuration, but can also be arranged in a length-wise configuration. In one embodiment, the frame 5 can include a cover 65 instead of a cushion assembly 10.

Frame 5 can also provide a structure that acts as a receiver for cushion assembly 10. Cushion assembly 10 is designed to fit onto the top of the frame 5 for another layer of shock absorption with added comfort. Cushion assembly 10 may be comprised of a memory foam cushion or other material that has a bottom 40, back 45 and opposing sides 50 and 55 with an open front. Back 45 and opposing sides 50 and 55 are elevated from the bottom.

Alternatively, frame 5 may be covered by cushion assembly 10 as shown in FIG. 5. Cushion assembly 10 is configured to fit around from 5 to add a layer of shock absorption as well as provide a protective cover for the frame 5.

In various preferred embodiments, the cushion assembly 10 is made from memory foam. Alternatively, cushion assembly 10 is covered with a durable fabric that may be waterproof, odor proof, washable, and/or removable. Other materials may be desired such as materials that provide support and ease of cleaning.

When in use the cushion assembly 10 provides animals being transported a variety of ways to find a comfortable position, either sitting, standing, leaning, or laying.

In another related embodiment, a layer of sodium polyacraylate may be included in the cushion assembly 10. This material is made for absorbing liquids. Other liquid absorbing materials are well known by one of ordinary skill in the art and are contemplated herein. Moreover, the cushion assembly 10 itself may also include odor absorbing materials.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A pet bed comprising
a base member having a top surface, a first sidewall and a second sidewall, each sidewall substantially perpendicular to the top surface and each of said sidewall bounding the top surface, the base member including a plurality of hollow cells disposed between the top surface and the first and second sidewalls, each of said hollow cells comprised of a set of cell walls, said cell walls defining a space therebetween; and
a pad member adapted to be supported by said base member, wherein said base member is configured to resiliently support said pad member when in use through at least a temporary partial deformation of said hollow cells.

2. The pet bed of claim 1, wherein the pad member includes a moisture absorbing material.

3. The pet bed of claim 1, wherein said base portion is made from a material selected from the group consisting of plastic, rubber, foam, and silicone.

4. The pet bed of claim 1, wherein said plurality of hollow cells are filled with a liquid or gas.

5. The pet bed of claim 1, wherein the base member is made substantially from a memory foam material .

6. The pet bed of claim 1, wherein the base member comprises a cover member.

7. The pet bed of claim 6, wherein the cover member is made from a material selected from fabric, sodium polyacraylate, and plastic.

8. The pet bed of claim 6, wherein the cover member is configured to be one of waterproof, odor proof, washable and removable.

9. The pet bed of claim 1, wherein said cell walls of said plurality of hollow cells are configured to form a support grid under said top surface of said base member.

10. The pet bed of claim 1 wherein a portion of the top surface and the first and second sidewalls of the base member are configured to form at least one upright member to provide side support for the pet.

11. The pet bed of claim 10 wherein the base member is configured to form more than one upright member to provide side support for the pet.

12. The pet bed of claim 11 wherein the pad member is configured to line the top surface and the upright members of the base member.

13. The pet bed of claim 1 wherein the cell walls are positioned substantially parallel to the side walls.

14. The pet bed of claim 1 wherein the cell walls are positioned substantially perpendicular to the side walls.

15. A pet bed comprising:
a base member having a top surface, a first sidewall and a second sidewall, each sidewall substantially perpendicular to the top surface and each of said sidewalls bounding the top surface, the base member including a plurality of hollow cells disposed between the top surface and the first and second sidewalls, each of said hollow cells comprised of a set of cell walls, said cell walls defining a space therebetween, wherein said cell walls of said plurality of hollow cells are configured to form a support grid under said top surface of said base member; and
an upright member formed from the base member and adapted to provide side support for the pet, said upright member formed from a portion of the base member and configured to be substantially perpendicular to the base member.

16. The pet bed of claim 15 further comprising a pad member disposed on the top surface of the base member and configured to line the base member and the upright member.

17. The pet bed of claim 16, wherein the pad member contains a moisture absorbing material.

18. The pet bed of claim 15, wherein the base member is made from a material selected from plastic, rubber, and silicone.

19. The pet bed of claim 15, wherein the hollow cells are filled with a liquid or gas.

20. The pet bed of claim 15, wherein the pad member is made of a memory foam type material.
